(19) United States
(12) Patent Application Publication
(10) Pub. No.: US 2010/0021186 A1
(43) Pub. Date: Jan. 28, 2010

(54) IMAGE FORMING APPARATUS

(75) Inventor: Tetsuya Okano, Anjo-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/510,555

(22) Filed: Jul. 28, 2009

(30) Foreign Application Priority Data
Jul. 28, 2008 (JP) 2008193968

(51) Int. Cl. G03G 15/00

(52) U.S. Cl. 399/21

(57) ABSTRACT

An image forming apparatus is provided and includes a transport unit which transports a recording medium; a plurality of image forming units provided so as to be individually retractable with respect to the transport unit, the image forming units forming images on the recording medium; a sensing unit sensing an occurrence of a jam; and a report unit. The reporting unit reports, when the sensing unit senses occurrence of a jam, an image forming unit from among the plurality of image forming units corresponding to a position of the recording medium on the transport unit.

### CROSS REFERENCE TO RELATED APPLICATION

The present application claims priority from Japanese Patent Application No. 2008-193968, which was filed on Jul. 28, 2008, the disclosure of which is herein incorporated by reference in its entirety.

### TECHNICAL FIELD

Apparatuses and devices consistent with the present invention relate to an image forming apparatus, and in particular, to jam handling in a direct tandem type image forming apparatus.

### BACKGROUND

In a related art direct tandem type image forming apparatus, for example, image forming units of respective colors are arranged along a belt transporting a sheet, and toner images of respective colors are sequentially transferred from the image forming units to the sheet being transported on the belt. A user who notices the occurrence of a jam, for example, open a cover of the apparatus, detaches one of the image forming units, and pulls out the sheet which has become jammed between the image forming unit and the belt, thereby clearing the jam.

When the above-described operation is performed to clear the jam, however, the user cannot know where the jam has occurred. In other words, the user does not know which image forming unit corresponds to the position of the jam. Accordingly, the user guesses and detaches one of the image forming units, and confirms with repetition (i.e., by trial and error) whether or not the sheet is present at the detached image forming unit, and whether or not the sheet can be pulled out. As a result, the operation efficiency is poor.

### SUMMARY

Accordingly, it is an aspect of the invention to provide a direct tandem type image forming apparatus that enables a smooth jam clear operation.

According to an illustrative aspect of the present invention, there is provided an image forming apparatus comprising: a transport unit which transports a recording medium carried thereon; a plurality of image forming units provided so as to be individually retractable with respect to the transport unit, the image forming units forming images on the recording medium carried on the transport unit; a sensing unit which senses an occurrence of a jam; and a report unit which reports, when the sensing unit senses the occurrence of a jam, an image forming unit from among the plurality of image forming units that corresponds to a position of the recording medium on the transport unit.

### BRIEF DESCRIPTION OF THE DRAWINGS

Illustrative aspects of the invention will be described in detail with reference to the following figures wherein:

FIG. 1 is a side sectional view showing the schematic configuration of a printer according to an exemplary embodiment of the invention;

FIG. 2 is a block diagram schematically showing the electrical configuration of the printer of FIG. 1;

FIG. 3 is a flowchart showing jam information display processing;

FIG. 4 is a flowchart showing clear position determination processing;

FIG. 5 is a flowchart showing a determination process for determining a position of a sheet based on a leading edge of the sheet;

FIG. 6 is a flowchart showing a determination process for determining a position of a sheet based on a trailing edge of the sheet;

FIG. 7 is a diagram illustrating a positional relationship between process cartridges and jam areas in the printer of FIG. 1;

FIG. 8 is a diagram illustrating an example of a leading edge of a sheet positioned in one of the jam areas of FIG. 7;

FIG. 9 is a diagram illustrating an example of a trailing edge of a sheet positioned in one of the jam areas of FIG. 7; and

FIG. 10 is a diagram illustrating an example of multiple sheets in the jam areas of FIG. 7.

### DETAILED DESCRIPTION OF EXEMPLARY EMBODIMENTS OF THE PRESENT INVENTION

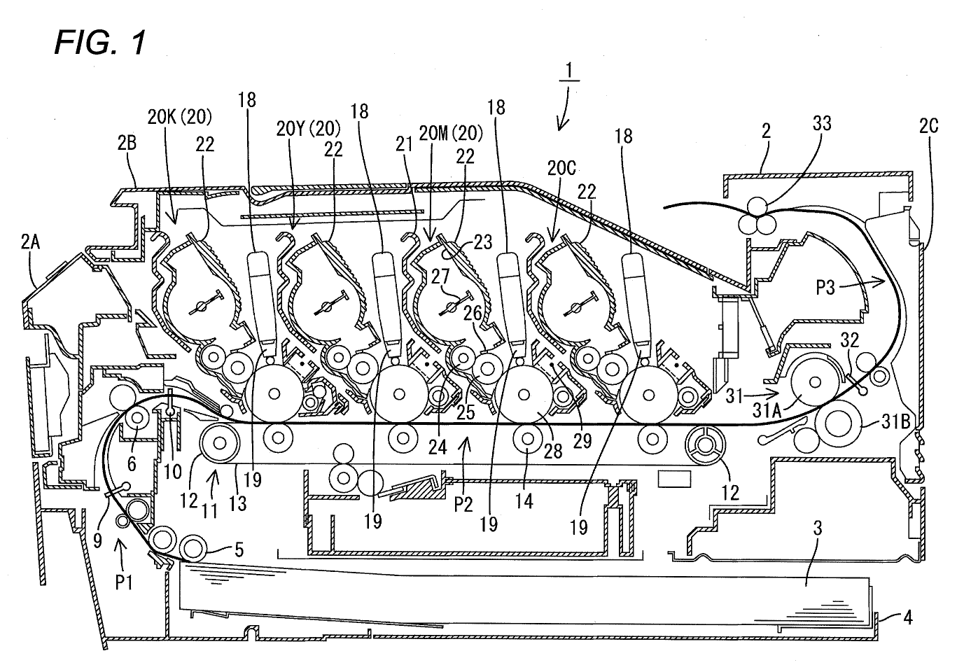

An exemplary embodiment of the invention will now be described with reference to FIGS. 1 to 10.

### 1. Overall Configuration of Printer

FIG. 1 is a side sectional view showing the schematic configuration of a printer 1 that is an example of an image forming apparatus of the invention. The printer 1 is a direct tandem type color printer that forms a color image by using toner of four colors (black K, yellow Y, magenta M, and cyan C). In the following description, the left side of FIG. 1 is referred to as a front side. In FIG. 1, with respect to the same parts for the respective colors, reference numerals will be appropriately omitted.

The printer 1 includes a main body casing 2, and at a bottom portion inside the main body casing 2, a feed tray 4 in which a plurality of sheets 3 (an example of a recording medium) are stacked is provided. At a front portion inside the main body casing 2, a transport path P1 is provided so as to be curved to have a U shape in side view. A feed roller 5 is provided above a front end of the feed tray 4, and an uppermost sheet 3 in the feed tray 4 is fed to the transport path P1 by rotation of the feed roller 5. At a front surface of the main body casing 2, a front cover 2A (an example of a cover) is provided so as to openably cover a part of the transport path P1, and if the front cover 2A is open, a part of the transport path P1 is exposed.

On the transport path P1, a pair of registration rollers 6 are provided. A registration roller front sensor 9 is disposed on an upstream side of the registration rollers 6, and a registration roller end sensor 10 (an example of a first sensor) is disposed on a downstream side of the registration rollers 6. The registration roller front sensor 9 and the registration roller end sensor 10 sense the presence/absence of the sheet 3 at respective positions. The registration rollers 6 corrects skew movement of the sheet 3, and transports the sheet 3 to a transport path P2 that is provided along an upper surface of a belt 13 of a belt unit 11.

The belt unit 11 is configured such that a ring-shaped belt 13 (an example of a transport unit) made of polycarbonate or the like is stretched between a pair of front and rear belt support rollers 12. If the rear belt support roller 12 is driven to rotate, the belt 13 is revolved in a clockwise direction of the drawing, and the sheet 3 carried on the upper surface of the belt 13 is transported backward. Four transfer rollers 14 are provided inside the belt 13.

Above the belt unit 11, exposure sections 18 and a process section 20 are provided. The exposure sections 18 include four light emitting diode (LED) units corresponding to respective colors of black, yellow, magenta, and cyan, respectively. Each exposure section 18 has an LED head 19 at its lower end. Each exposure section 18 is configured such that light emission is controlled on the basis of image data to be formed, and irradiates light from the LED head 19 to a photosensitive drum 28.

The process section 20 includes four process cartridges 20K, 20Y, 20M, and 20C (an example of image forming units) corresponding to the four colors. The four process cartridges 20K to 20C are arranged in a front-back direction such that the lower surface thereof is opposite the upper surface of the belt 13.

At an upper surface of the main body casing 2, a top cover 2B is openably provided so as to cover the exposure sections 18 and the process section 20. The top cover 2B supports the exposure sections 18. If the top cover 2B is opened, the exposure sections 18 are retracted upward along with the top cover 2B, such that the process cartridges 20K to 20C can be attached and detached with respect to the main body casing 2. In other words, the process cartridges 20K to 20C can be individually retracted upward (in a vertical direction) with respect to the belt 13.

Each of the process cartridges 20K to 20C includes a cartridge frame 21 and a developing cartridge 22, which is detachably mounted with respect to the cartridge frame 21. Each developing cartridge 22 includes a toner accommodating chamber 23 accommodating toner for each color as a developer. A supply roller 24, a developing roller 25, a layer thickness regulating blade 26, an agitator 27, and the like are provided below the toner accommodating chamber 23.

Toner emitted from the toner accommodating chamber 23 is supplied to the developing roller 25 by rotation of the supply roller 24, and is positively frictionally changed between the supply roller 24 and the developing roller 25. Toner that is supplied onto the developing roller 25 enters between the layer thickness regulating blade 26 and the developing roller 25 by rotation of the developing roller 25, is sufficiently frictionally charged, and is carried on the developing roller 25 as a thin layer of a predetermined thickness.

Below the cartridge frame 21, a photosensitive drum 28, the surface of which is covered with a positively chargeable photosensitive layer, and a scorotron type charger 29 are provided. The photosensitive drum 28 forms a nip portion with the corresponding transfer roller 14 with the belt 13 interposed therebetween. At the time of image formation, the surface of the photosensitive drum 28 is uniformly positively charged by the charger 29. The positively charged portion is exposed by the exposure section 18, and an electrostatic latent image is formed on the surface of the photosensitive drum 28.

Next, toner that is carried on the developing roller 25 and positively charged is supplied to the electrostatic latent image on the surface of the photosensitive drum 28. As a result, the electrostatic latent image on the photosensitive drum 28 is 10 visualized. Thereafter, toner images carried on the surfaces of the respective photosensitive drums 28 are sequentially transferred to the sheet 3 by a negative transfer voltage to be applied to the transfer rollers 14 while the sheet 3 is passing through the nip positions between the photosensitive drums 28 and the transfer rollers 14.

At a rear portion inside the main body casing 2, a transport path P3 is provided so as to be curved to have a U shape in side view. At a rear surface of the main body casing 2, a rear cover 2C (an example of a cover) is provided so as to openably cover a transport path P3. If the rear cover 2C is open, a part of the transport path P3 can be exposed. The sheet 3 to which the toner images are transferred is transported to a fixer 31, which is provided on the transport path P3, by the belt unit 11.

The fixer 31 includes a heating roller 31A having a heat source, and a pressing roller 31B pressing the sheet 3 toward the heating roller 31A. While the sheet 3 is passing through the fixer 31, an image forming surface of the sheet 3 is pressed into contact with the heating roller 31A, and thus the transferred toner images are thermally fixed onto the surface of the sheet. A paper discharge sensor 32 (an example of a second sensor) is provided on a downstream side of the fixer 31 so as to sense presence/absence of the sheet 3. The sheet 3 onto which the toner images are thermally fixed by the fixer 31 is transported upward along the transport path P3, and is discharged onto an upper surface of the cover 2B by a discharge roller 33 provided at an upper end of the transport path P3.

### 2. Electrical Configuration

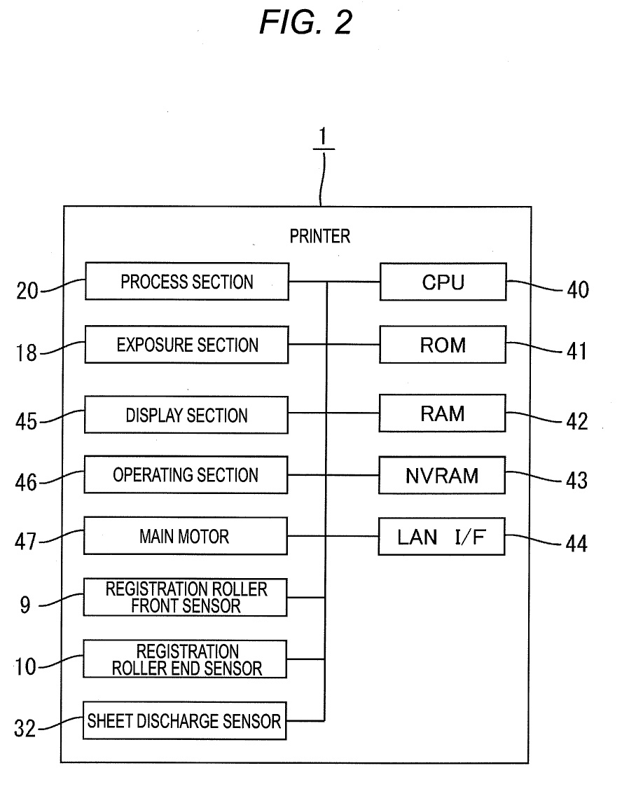

FIG. 2 is a block diagram schematically showing the electrical configuration of the printer 1.

As shown in FIG. 2, the printer 1 includes a central processing unit (CPU) 40 (an example of a report unit), a read only memory (ROM) 41, a random access memory (RAM) 42, a nonvolatile random access memory (NVRAM) 43, and a network interface 44. The process section 20, the exposure section 18, the registration roller front sensor 9, the registration roller end sensor 10, and the paper discharge sensor 32, or a display section 45, an operating section 46, a main motor 47, and the like are connected to the CPU 40, the RAM 41, the ROM 42, the NVRAM 43, and the network interface 44.

The ROM 41 stores various programs for executing the operation of the printer 1, such as a jam information display processing described below or the like. The CPU 40 controls the respective sections in accordance with the programs read out from the ROM 41 while storing the processing result in the RAM 42 or the NVRAM 43. The network interface 44 is connected to an external computer (not shown) or the like through a communication line, such that mutual data communication is possible.

The display section 45 includes a liquid crystal display or a lamp, and can display various setup screens, the operation state of the apparatus, or the like. The operating section 46 includes a plurality of buttons, and allows a user to carry out various input operations. The main motor 47 rotates the feed roller 5, the registration roller 6, the belt support rollers 12, the developing rollers 25, the photosensitive drums 28, the heating roller 31A, and the like through a gear mechanism (not shown).

### 3. Jam Information Display Processing

Next, the operation of a jam information display processing to be executed under the control of the CPU 40 will be described.

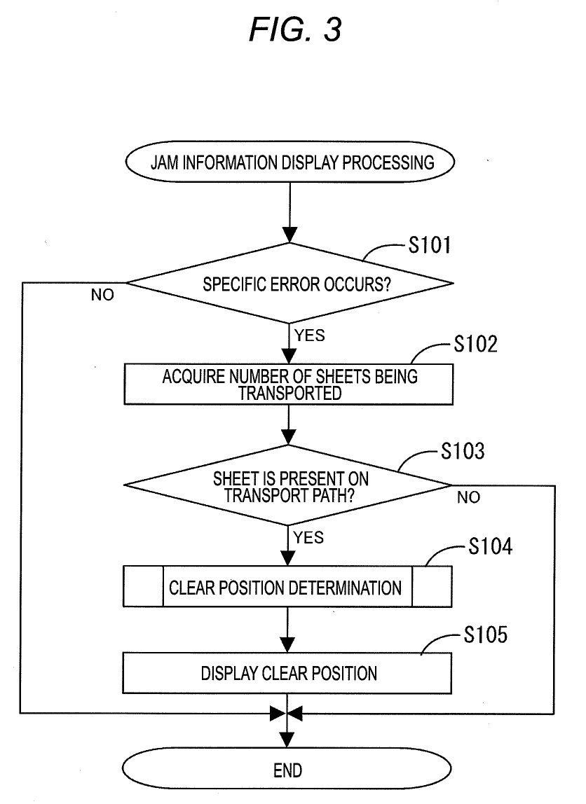

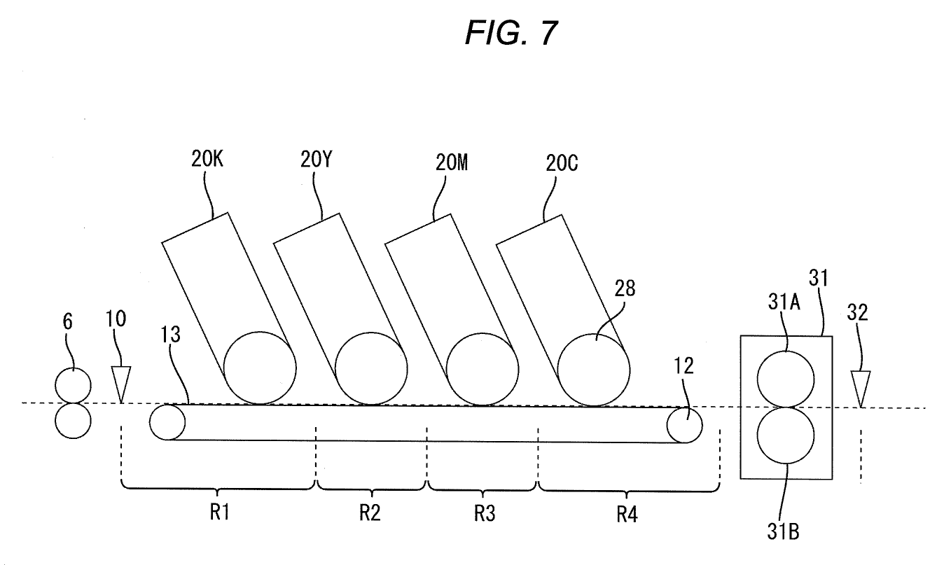

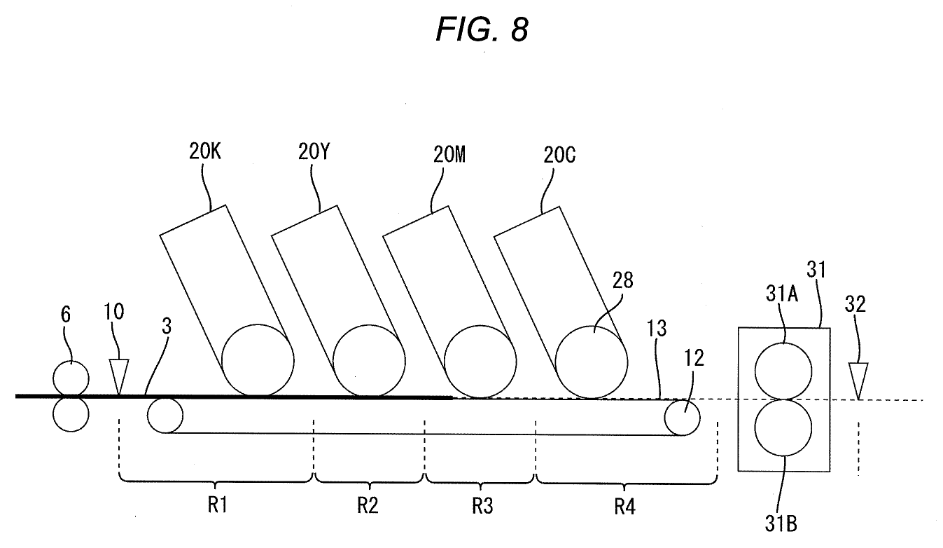

FIGS. 3 to 6 are flowcharts showing the flow of the jam information display processing. FIG. 7 is a diagram illustrating the positional relationship between the process cartridges 20K to 20C and jam areas R1 to R4. FIGS. 8 to 10 are diagrams illustrating the positional relationship between the sheet 3, the jam areas R1 to R4, and the process cartridges 20K to 20C.

The jam information display processing is a processing for displaying information on clearing of a jam state on the display section 45 when a jam error occurs, and is regularly executed by the CPU 40. As shown in FIG. 3, the CPU 40 first determines whether or not a specific error occurs during an image forming processing (S101), and when no error occurs (S101: No), ends the processing. The CPU 40 senses various kinds of errors during the image forming processing, and if a specific error is sensed, aborts the image forming operation and stops driving of the main motor 47. If the sheet 3 being transported is present when the main motor 47 stops, the sheet 3 is stopped and stranded in a position within the transport paths P1 to P3.

The specific error includes, for example, when a cover open/close sensor (not shown) senses that one of the covers 2A, 2B, and 2C of the main body casing 2 is open during the image forming processing, when a temperature sensor (not shown) senses that the temperature of the fixer 31 is abnormal, or when it is sensed that a transport error of the sheet 3 occurs. The transport error of the sheet 3 is sensed by the registration roller front sensor 9, the registration roller end sensor 10, and the paper discharge sensor 32. For example, when the registration roller front sensor 9 is not turned on within a period after the feed roller 5 starts to rotate, it is determined that a transport error due to a sheet piece occurs. When the registration roller end sensor 10 is not turned on within a period after the registration roller front sensor 9 is turned on, or when the paper discharge sensor 32 is not turned on within a period after the registration roller end sensor 10 is turned on, it is determined that a transport error due to sheet clogging occurs.

When it is sensed that the specific error occurs (S101: Yes), the CPU 40 acquires the number of sheets 3 on the transport paths P1 to P3 (S102). The CPU 40 acquires information on the length of the sheet 3 on the basis of a time during the image forming processing from when the leading end of the sheet 3 turns on the registration roller front sensor 9 (or the registration roller end sensor 10) until the trailing end of the sheet 3 passes through the sensor 9 (or 10) and turns off the sensor 9 (or 10), and the transport speed of the sheet 3. In this processing, the position of the sheet 3 stranded on each of the transport paths P1 to P3 is calculated on the basis of a time from when the leading end of the sheet 3 turns on one of the registration roller front sensor 9, the registration roller end sensor 10, and the paper discharge sensor 32 until the main motor 47 stops, the transport speed of the sheet 3, and the length of the sheet 3. On the basis of the calculation result, the number of sheets 3 on the transport paths P1 to P3 is acquired.

When no sheet 3 is present on the transport paths P1 to P3 (S103: No), the jam information display processing ends. Meanwhile, when a sheet 3 is present on any one of the transport paths P1 to P3 (S103: Yes), the following clear position determination processing is executed (S104).

### (Clear Position Determination Processing)

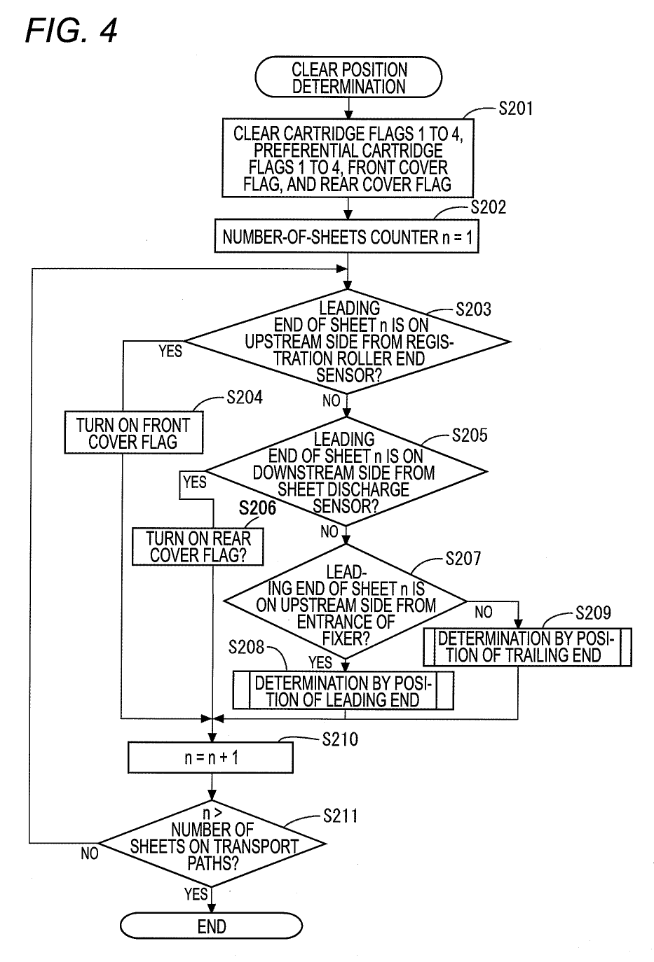

The clear position determination processing is processing for determining a portion along the transport paths P1 to P3 where a jam state clear operation (removal of the sheet 3) should be carried out. As shown in FIG. 4, if the clear position determination processing starts, the CPU 40 first clears cartridge flags 1 to 4, preferential cartridge flags 1 to 4, a front cover flag, and a rear cover flag, which are stored in the RAM 42 (S201). The flags indicate whether or not the process cartridges 20K to 20C, the front cover 2A, and the rear cover 2C is a portion where the clear operation should be carried out. The cartridge flags 1 to 4 and the preferential cartridge flags 1 to 4 correspond to the process cartridges 20K to 20C that are positioned in a numerical order when counted from the upstream side, respectively.

Next, the CPU 40 sets a counter n, indicating the number of sheets, to 1 (S202). Then, the CPU 40 determines whether or not the leading end of an n-th sheet 3 is at a position (regular position) on the upstream side from the registration roller end sensor 10 (S203). When the leading end of the n-th sheet 3 is at the position on the upstream side (S203: Yes), the front cover flag is turned on (S204). When the leading end of the n-th sheet 3 is at a position (regular position) on the downstream side from the paper discharge sensor 32 (S203: No, S205: Yes), the rear cover flag is turned on (S206).

When the leading end of the n-th sheet 3 is upstream from the entrance of the fixer 31 (S203: No, S205: No, S207: Yes), as described below, determination by the position of the leading end of the sheet 3 is carried out (S208). When the leading end of the n-th sheet 3 is downstream from the entrance of the fixer 31 (S207: No), determination by the position of the trailing end of the sheet 3 is carried out (S209).

As shown in FIG. 7, of the transport paths P1 to P3, an area (corresponding to the transport path P2) from the registration roller end sensor 10 to the entrance of the fixer 31 is divided into four jam areas R1 to R4 in association with the process cartridges 20K to 20C. Each of the jam areas R1 to R4 is positioned immediately below a corresponding one of the process cartridges 20K to 20C, and each jam area R1 to R4 spans the corresponding nip position of the corresponding process cartridge. In other words, each jam area R1 to R4 includes a portion of the transport path located upstream of the corresponding nip position and a portion of the transport path located downstream of the corresponding nip position.

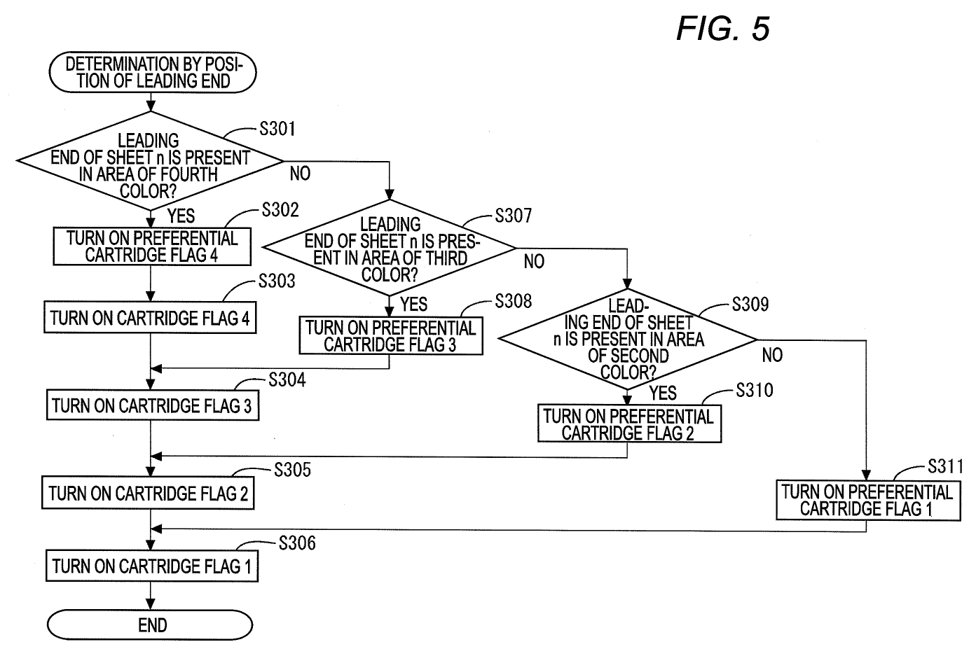

At the time of determination by the position of the leading end of the sheet 3, as shown in FIG. 5, the CPU 40 determines in which of the jam areas R1 to R4 of the respective colors the leading end of the sheet 3 is positioned. When the leading end of the sheet 3 is positioned in the area R4 of the fourth color (S301: Yes), the preferential cartridge flag 4 corresponding to the jam area R4 is turned on (S302), and the cartridge flags 1 to 4 corresponding to the jam area R4 and the jam areas R1 to R3 on the upstream side from the area R4 are turned on (S303 to S306).

When the leading end of the sheet 3 is positioned in the jam area R3 of the third color (S301: No and S307: Yes), the preferential cartridge flag 3 corresponding to the jam area R3 is turned on (S308), and the cartridge flags 1 to 3 corresponding to the jam area R3 and the jam areas R1 and R2 on the upstream side from the jam area R3 are turned on (S304 to S306). Similarly, when the leading end of the sheet 3 is positioned in the jam area R2 of the second color (S301: No, S307: No, and S309: Yes), the preferential cartridge flag 2 corresponding to the jam area R2 and the cartridge flags 1 and 2 are turned on (S310, S305, and S306). When the leading end of the sheet 3 is positioned in the jam area R1 of the first color (S301: No, S307: No, and S309: No), the preferential cartridge flag 1 and the cartridge flag 1 are turned on (S311 and S306).

For example, when the sheet 3 is present at a position shown in FIG. 8, the preferential cartridge flag 3 corresponding to the third process cartridge 20M is turned on, and the cartridge flags 1 to 3 corresponding to the first to third process cartridges 20K to 20M are turned on.

While the cartridge flags 1 to 4 that are turned on during the above processing principally correspond to the position of the sheet 3; in a case in which a length of the sheet 3 is comparatively short, the cartridge flags 1 to 4 may not correspond to the position of the sheet 3. For example, when the leading end of the sheet 3 is positioned in the jam area R4 and the trailing end of the sheet 3 is present in the jam area R2, the sheet 3 is absent in the jam area R1. However, in this case, the cartridge flag 1 is turned on. In such a case, the position of the trailing end of the sheet may also be specified, and only the cartridge flags 2 to 4 corresponding to the jam areas R2 to R4 may be turned on.

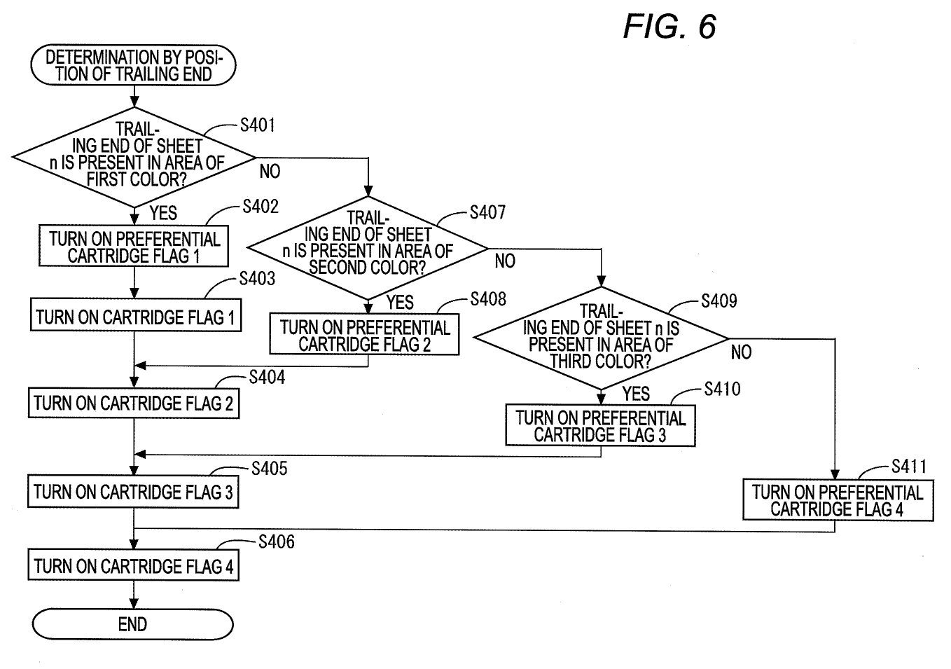

At the time of determination by the position of the trailing end of the sheet 3, as shown in FIG. 6, the CPU 40 determines in which of the areas R1 to R4 of the respective colors the trailing end of the sheet 3 is positioned. That is, when the trailing end of the sheet 3 is positioned in the jam area R1 of the first color (S401: Yes), the preferential cartridge flag 1 corresponding to the area R1 and the cartridge flags 1 to 4 corresponding to the jam area R1 and the jam areas R2 to R4 on the downstream side from the jam area R1 are turned on (S402 to S406). When the trailing end of the sheet 3 is positioned in the jam area R2 of the second color (S401: No and S407: Yes), the preferential cartridge flag 2 and the cartridge flags 2 to 4 are turned on (S408 and S404 to S406).

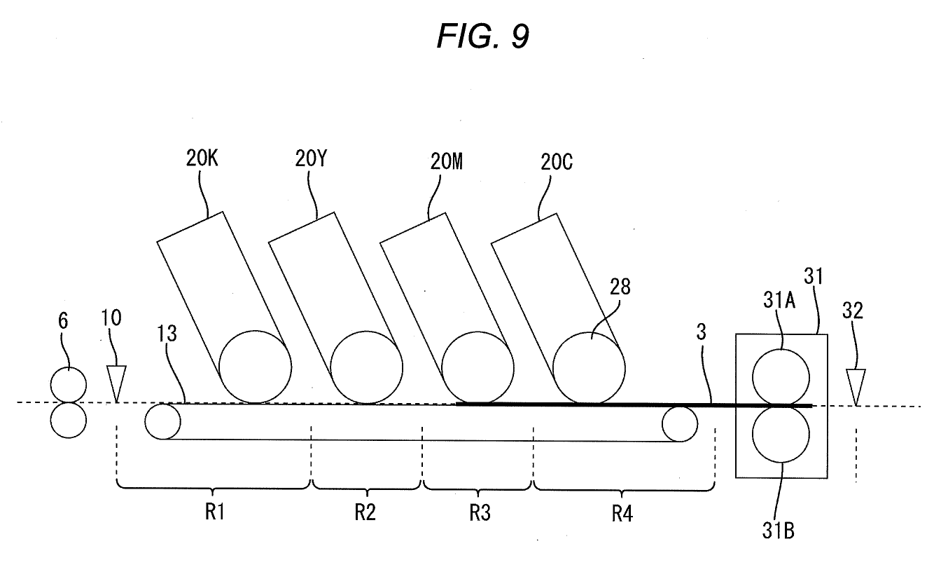

Similarly, when the trailing end of the sheet 3 is positioned in the jam area R3 of the third color (S401: No, S407: No, and S409: Yes), the preferential cartridge flag 3 and the cartridge flags 3 and 4 are turned on (S410, S405, and S406). When the trailing end of the sheet 3 is positioned in the jam area R4 of the fourth color (S401: No, S407: No, and S409: No), the preferential cartridge flag 4 and the cartridge flag 4 are turned on (S411 and S406). For example, when the sheet 3 is present at a position shown in FIG. 9, the preferential cartridge flag 3 corresponding to the third process cartridge 20M is turned on, and the cartridge flags 3 and 4 corresponding to the third and fourth process cartridges 20M and 20C are turned on.

In this exemplary embodiment, when the leading end of a sheet 3 having a maximum length being usable in the printer 1 is present at the entrance of the fixer 31, the trailing end of the sheet 3 is set so as to be necessarily present in one of the jam areas R1 to R4. While in the above processing, the processing (S207) for switching determination of the leading end and the trailing end of the sheet 3 is carried out on the basis of the position of the leading end of the sheet 3, this is not intended to limit the invention. For example, determination of which of the jam areas R1 to R4 the trailing end of the sheet 3 is positioned in may be carried out on the basis of the sensing result of the registration roller end sensor 10.

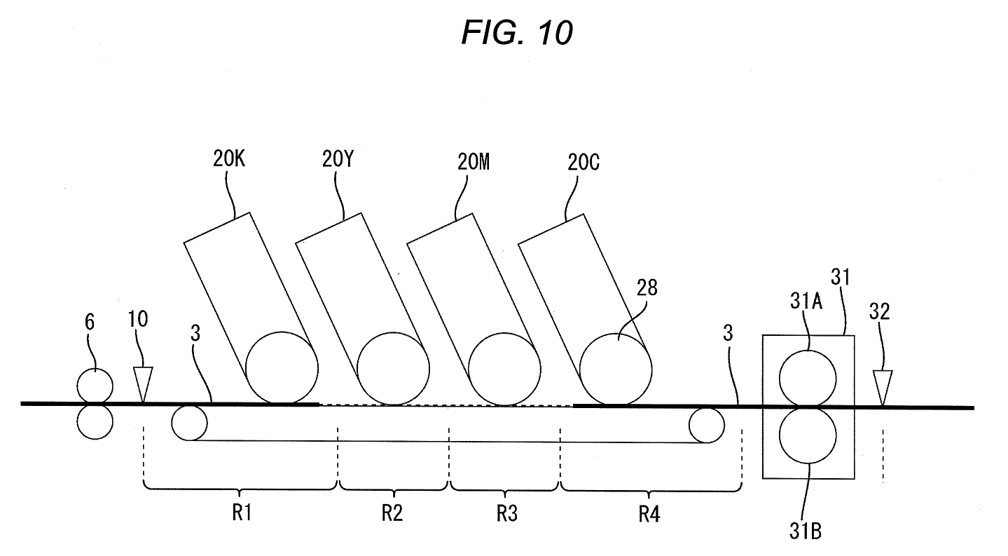

In S204, S206, S208, and S209 of FIG. 4, the CPU 40 changes the value of the flag, and increments the counter n by one (S210). When the value n does not exceed the number of sheets 3 on the transport paths (S211: No), the processing returns to S203, and the same processing is repeated for the next sheet 3. Therefore, for example, when two sheets 3 are present at positions shown in FIG. 10, the preferential cartridge flag 1 and the cartridge flag 1 corresponding to the first process cartridge 20K, and the preferential cartridge flag 4 and the cartridge flag 4 corresponding to the fourth process cartridge 20C are turned on. When the value n exceeds the number of sheets 3 on the transport paths (S211: Yes), the clear position determination processing ends.

After the clear position determination processing of S104 in FIG. 3 ends, the CPU 40 displays information for jam clear on the display section 45 on the basis of the values of the above-described flags (S105). That is, when the front cover flag is turned on, display is performed to ask the user to carry out jam clear from the front cover 2A. When the rear cover flag is turned on, display is performed to ask the user to carry out jam clear from the rear cover 2C.

When one or more of the cartridge flags 1 to 4 is turned on, the CPU 40 displays the process cartridges 20K to 20C corresponding to the turned-on cartridge flags 1 to 4 on the display section 45 as candidates to be detached to clear the jam. Then, the process cartridge 20C corresponding to the preferential cartridge flag 4 from among the process cartridges 20K to 20C is displayed as a process cartridge to be preferentially detached while being distinguished from other process cartridges 20K to 20M.

For example, as shown in FIG. 8, when the leading end of the sheet 3 is positioned in the jam area R3, a message is displayed to inform the user that the process cartridge 20M of the third color with the preferential cartridge flag 3 turned on should be initially detached, and that, if it is not possible to clear the jam by only removing the process cartridge 20M of the third color, the first and second process cartridges 20K and 20Y should be detached next in order to clear the jam.

The user who sees the message can first view the leading end of the sheet 3 exposed when the process cartridge 20M of the third color is detached, and can grip and pull the leading end so as to remove the sheet 3. In a state where a single sheet 3 is nipped between a plurality of process cartridges 20K and 20Y, the end of the sheet 3 may be pulled to pull out the entire sheet 3. When the sheet 3 is successfully pulled out, it is not necessary to detach all the displayed process cartridges 20K and 20Y Meanwhile, when the sheet 3 is not pulled out in a state where only the preferentially displayed process cartridge 20M is detached, all or some of other displayed process cartridges 20K and 20Y are detached so as to try to remove the sheet 3 again.

When there are a plurality of sheets 3 on the transport paths P1 to P3, the CPU 40 displays the covers 2A and 2C or the process cartridges 20K to 20C that are operable for clear with respect to the sheet 3. For example, as shown in FIG. 10, when the preferential cartridge flags 1 and 4 are turned on, an indication is displayed that the corresponding process cartridges 20K and 20C should be detached so as to remove two sheets 3.

In a case in which the process cartridges 20K to 20C are detached and only an intermediate portion of the sheet 3 is exposed, the user will have difficulty in gripping the sheet 3. In contrast, in this exemplary embodiment, since the end of the sheet 3 is exposed at the position of the initially detached one of the process cartridges 20K to 20C, the user can easily grip the sheet 3. If the user grips the intermediate portion of the sheet 3, unfixed toner may be stuck to the user's hands. In contrast, in this exemplary embodiment, if the user grips the end of the sheet 3, there is a high possibility that the user grips a portion of the sheet where no toner is stuck, and thus the user can more easily avoid contact with the unfixed toner.

As described above, according to this exemplary embodiment, when a jam occurs, a process cartridge corresponding to the position of the sheet 3 on the belt 13 from among the process cartridges 20K to 20C is reported. Therefore, the user retracts the reported process cartridge from among the process cartridges 20K to 20C so as to easily pull out the sheet 3 on the belt 13 and to smoothly clear the jam.

The CPU 40 detects the position of the sheet 3 when a jam occurs and reports a process cartridge corresponding to the position of the sheet 3 from among the process cartridges 20K to 20C on the basis of the detection result. In some related art printers, when a jam occurs, the sheet is transported to a regular position, and an image forming unit corresponding to the sheet at the regular position may be reported. In the case of this related art printer, however, the clogging state of the sheet may get worse according to circumstances. In contrast, according to the exemplary embodiment of the invention, when a jam occurs, the sheet 3 is not moved further, and thus the clogging state can be prevented from getting worse.

The process cartridge corresponding to the position of the end of the sheet 3 from among the process cartridges 20K to 20C is reported while being distinguished from other process cartridges from among the process cartridges 20K to 20C. Therefore, the user retracts the process cartridge corresponding to the position of the end of the sheet 3 from among the process cartridges 20K to 20C and grips the end of the sheet 3 so as to easily clear the jam.

As the process cartridge corresponding to the position of the end of the sheet 3, the process cartridges 20K to 20C, a process cartridge around which the end of the sheet 3 is positioned within a predetermined range astride the upstream side and the downstream side of the nip position on the belt 13 is reported. Therefore, the user retracts the process cartridges 20K to 20C so as to grip the end of the sheet 3.

It is possible to switch whether a process cartridge corresponding to the leading end of the sheet 3 or a process cartridge corresponding to the trailing end of the sheet 3 is reported from among the process cartridges 20K to 20C on the basis of the sensing results of the registration roller end sensor 10 and the paper discharge sensor 32 provided on the upstream side and the downstream side of the belt 13, respectively.

When a jam occurs, if the other end of the sheet 3 is present at a position corresponding to the cover 2A or 2C on the upstream side or the downstream side of the belt 13, an indication that jam clear from the cover 2A or 2C is possible is reported, instead of reporting a process cartridge from among the process cartridges 20K to 20C. Therefore, when jam clear from the cover 2A or 2C is possible, a clear operation can be carried out without retracting the process cartridges 20K to 20C.

The retraction order of the process cartridges 20K to 20C is decided, and process cartridges 20K to 20C are reported on the basis of the order. For this reason, the user retracts the process cartridges 20K to 20C on the basis of the reported order so as to smoothly carry out a jam clear operation. For example, if the jam state can be cleared in a state where the higher-order process cartridge from among the process cartridges 20K to 20C is retracted, it is not necessary to retract the lower-order process cartridges from among the process cartridges 20K to 20C.

When a jam occurs, if there are a plurality of sheets 3, a process cartridge corresponding to the position of each sheet 3 from among the process cartridges 20K to 20C is reported. Therefore, even if a plurality of sheets 3 are jammed, the jam clear operation can be appropriately carried out.

The plurality of process cartridges 20K to 20C can be individually detached in the vertical direction with respect to the transport surface of the belt 13. If the invention is applied to such a configuration, workability of the jam clear operation can be effectively improved.

### Additional Exemplary Embodiments

The invention is not limited to the exemplary embodiment described above and shown in the drawings, and the following exemplary embodiments also fall within the technical scope of the invention.

(1) In the foregoing exemplary embodiment, a process cartridge corresponding to the position of the end of the sheet on the belt and a process cartridge corresponding to the position of the sheet are reported. Alternatively, according to the invention, only a process cartridge corresponding to the position of the end of the sheet may be reported. In this case, if the user detaches the cartridge corresponding to the position of the end of the sheet and confirms the position of the end of the sheet, the user can grasp the position of the entire sheet. Therefore, even if the sheet is not pulled out from this state, the user can easily grasp other cartridges that should be detached.

(2) As the method of reporting to the user a process cartridge that should be detached, for example, a lamp disposed at a position corresponding to each process cartridge may be turned on or a process cartridge may be informed by sound. In addition, the positional relationship between the sheet and the cartridges may be graphically displayed on a liquid crystal display or the like.

(3) In the foregoing exemplary embodiment, when there are a plurality of process cartridges corresponding to the position of the sheet on the belt, a process cartridge corresponding to the position of the end of the sheet is set as a higher-order process cartridge, and other process cartridges are set as a lower-order process cartridge. Alternatively, a way to give priority over the process cartridges to be retracted may be appropriately changed. For example, a process cartridge corresponding to the position of one end of the sheet may be set as a highest-order process cartridge, and a process cartridge closer to the other end of the sheet may be set as a lower-order process cartridge. That is, in FIG. 7, for example, the priority may be given in an order of the process cartridges 20M, 20Y, and 20K. While the process cartridges are sequentially detached starting with a higher priority process cartridge, a test on whether or not the sheet can be removed is carried out. In this way, the jam clear operation can be efficiently carried out.

(4) While the process cartridges as the candidates to be detached may not be displayed at a time, a higher priority process cartridge may be first displayed, and a lower priority process cartridge may be subsequently displayed. For example, a higher priority cartridge may be first displayed, the user may be allowed to input from the operating section 46 whether or not the sheet can be removed when the process cartridge is detached, and when the sheet cannot be removed, a next lower priority process cartridge may be displayed.

(5) In the foregoing exemplary embodiment, when the transport error of the sheet occurs, a process cartridge corresponding to the position of the sheet may not be accurately reported. Alternatively, if a process cartridge that is likely to make it possible to remove the sheet is reported, the jam clear operation can be efficiently carried out. For example, when a transport error occurs that the sheet does not reach the paper discharge sensor within a predetermined period, an indication may be reported that the process cartridges should be detached sequentially starting with a process cartridge on the upstream side so as to remove the sheet.

(6) Although in the foregoing exemplary embodiment, a case where the belt is used as a transport unit has been described, the invention may be applied to an image forming apparatus that transports a recording medium while being carried in the vicinity of a drum.

(7) Although in the foregoing exemplary embodiment, a case where the process cartridges of the respective colors are detached has been described, the invention may be applied to an image forming apparatus in which jam clear is possible when at least a part of the image forming unit is retracted with respect to a transport unit.

According to a first illustrative aspect of the invention, there is provided an image forming apparatus comprising: a transport unit transporting a recording medium carried thereon; a plurality of image forming units provided so as to be individually retracted with respect to the transport unit, the image forming units forming images on the recording medium carried on the transport unit; a sensing unit sensing occurrence of a jam; and a report unit reporting, when the sensing unit senses occurrence of a jam, an image forming unit corresponding to the position of the recording medium on the transport unit from among the plurality of image forming units.

According to the first illustrative aspect of the invention, when a jam occurs, an image forming unit corresponding to the position of the recording medium on the transport unit is reported. Therefore, the user retracts the reported image forming unit so as to easily pull out the recording medium on the transport unit and to smoothly clear the jam.

According to a second illustrative aspect of the invention, the image forming apparatus may further comprise: a detection unit detecting the position of the recording medium when a jam occurs, wherein the report unit reports the image forming unit corresponding to the position of the recording medium on the basis of the detection result of the detection unit.

According to the second illustrative aspect of the invention, the detection unit that, when a jam occurs, detects the position of the recording medium is provided, and an image forming unit corresponding to the position of the recording medium may be reported on the basis of the detection result. Thus, in contrast to a case in which when a jam occurs, the recording medium is transported to a regular position which may cause the clogging state to get worse, according to this illustrative aspect of the invention, when a jam occurs, the recording medium is not moved, and thus the clogging state can be prevented from getting worse.

According to a third illustrative aspect of the invention, the report unit may report an image forming unit corresponding to the position of at least one of a leading end and a trailing end of the recording medium on the transport unit while being distinguished from other image forming units.

According to the third illustrative aspect of the invention, an image forming unit corresponding to the position of an end of the recording medium is reported while being distinguished from other image forming units. Therefore, the user may retract the image forming unit corresponding to the position of the end of the sheet and grip the end of the recording medium so as to easily clear the jam.

According to a fourth illustrative aspect of the invention, each of the image forming units may form a nip portion with the transport unit, and the report unit may report, as an image forming unit corresponding to the position of an end of the recording medium, an image forming unit when the end of the recording medium is positioned within a range astride an upstream side and a downstream side of the position of the corresponding nip portion on the transport unit.

According to the fourth illustrative aspect of the invention, as an image forming unit, an image forming unit when the end of the recording medium may be positioned within a range astride the upstream side and the downstream side of the position of the corresponding nip portion on the transport unit. Therefore, the user may retract the image forming unit so as to grip the end of the recording medium.

According to a fifth illustrative aspect of the invention, the detection unit may include a first sensor disposed on an upstream side of the transport unit to sense a presence/absence of the recording medium, and a second sensor disposed on a downstream side of the transport unit to sense a presence/absence of the recording medium, and when a jam occurs, the report unit may switch whether to report an image forming unit corresponding to the position of the leading end of the recording medium on the transport unit or an image forming unit corresponding to the position of the trailing end of the recording medium on the basis of the sensing result of at least one of the first sensor and the second sensor.

According to the fifth illustrative aspect of the invention, it is possible to switch whether an image forming unit corresponding to the leading end of the recording medium or an image forming unit corresponding to the trailing end of the recording medium on the basis of the sensing results of the first and second sensors provided on the upstream side and the downstream side of the transport unit, respectively.

According to a sixth illustrative aspect of the invention, the image forming apparatus may further comprise: a cover openably covering a transport path of the recording medium on at least one of an upstream side and a downstream side of the transport unit, wherein, when a jam occurs, the report unit determines whether or not the other end of the recording medium, one end of which is positioned on the transport unit, is at a regular position corresponding to the cover, and when it is determined that the other end of the recording medium is at the regular position, reports an indication that jam clear from the cover is possible, instead of reporting the image forming unit.

According to the sixth illustrative aspect of the invention, when a jam occurs, if the other end of the recording medium is present at the regular position corresponding to the cover on the upstream side or the downstream side of the transport unit, an indication that jam clear from the cover is possible is reported, instead of reporting an image forming unit. Therefore, when jam clear from the cover is possible, a clear operation can be carried out without retracting the image forming unit.

According to a seventh illustrative aspect of the invention, when there are a plurality of image forming units corresponding to the position of the recording medium, the report unit may decide a retraction order of the image forming units, and report the image forming units on the basis of the decided order.

According to the seventh illustrative aspect of the invention, the retraction order of the image forming units is decided, and the image forming units are reported on the basis of the order. For this reason, the user may retract the image forming units on the basis of the reported order so as to smoothly carry out a jam clear operation.

According to an eighth illustrative aspect of the invention, when the order is decided, the report unit may set, as an highest-order image forming unit, an image forming unit corresponding to the position of one of a leading end and a trailing end of the recording medium on the transport unit from among the plurality of image forming unit, and may set, as a lower-order image forming unit, an image forming unit closer to the other end of the recording medium.

According to the eighth illustrative aspect of the invention, when the retraction order of the image forming units is decided, an image forming unit corresponding to the position of one end of the recording medium is set as the highest-order image forming unit, and an image forming unit closer to the other end of the recording medium is set as a lower-order image forming unit. Therefore, the user can initially grip the end of the recording medium and thus can easily pull out the recording medium.

According to a ninth illustrative aspect of the invention, when a jam occurs, if a plurality of recording mediums are present on the transport unit, the report unit may report an image forming unit corresponding to the position of each recording medium.

According to the ninth illustrative aspect of the invention, when a jam occurs, if there are a plurality of recording mediums, an image forming unit corresponding to the position of each recording medium is reported. Therefore, even if a plurality of recording mediums are jammed, the jam clear operation can be appropriately carried out.

According to a tenth illustrative aspect of the invention, the plurality of image forming units may be configured to be individually detached in a vertical direction with respect to a transport surface of the recording medium in the transport unit.

According to the tenth illustrative aspect of the invention, a plurality of image forming unit can be individually detached in the vertical direction with respect to the transport surface of the recording medium in the transport unit. If the invention is applied to such a configuration, workability of the jam clear operation can be effectively improved.

According to the above described aspects, when a jam occurs, an image forming unit corresponding to the position of the recording medium on the transport unit is reported. Therefore, the user retracts the reported image forming unit so as to easily pull out the recording medium on the transport unit and to smoothly clear the jam.

While the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming apparatus comprising:
a transport unit which transports a recording medium carried thereon;
a plurality of image forming units provided so as to be individually retractable with respect to the transport unit, the image forming units forming images on the recording medium carried on the transport unit;
a sensing unit which senses an occurrence of a jam; and
a report unit which reports, when the sensing unit senses the occurrence of a jam, an image forming unit from among the plurality of image forming units that corresponds to a position of the recording medium on the transport unit.

2. The image forming apparatus according to claim 1, further comprising:
a detection unit which detects the position of the recording medium when a jam occurs,
wherein the report unit reports the image forming unit corresponding to the position of the recording medium on the basis of the detection result of the detection unit.

3. The image forming apparatus according to claim 2,
wherein the report unit reports an image forming unit corresponding to a position of at least one of a leading end and a trailing end of the recording medium on the transport unit while being distinguished from other image forming units.

4. The image forming apparatus according to claim 3,
wherein each of the image forming units forms a nip portion with the transport unit, and
the report unit reports, as an image forming unit corresponding to the position of an end of the recording medium, an image forming unit when the end of the recording medium is positioned within a predetermined range astride an upstream side and a downstream side of the position of the corresponding nip portion on the transport unit.

5. The image forming apparatus according to claim 3,
wherein the detection unit comprises a first sensor disposed on an upstream side of the transport unit to sense the recording medium, and a second sensor disposed on a downstream side of the transport unit to sense the recording medium, and
when a jam occurs, the report unit switches whether to report an image forming unit corresponding to the position of the leading end of the recording medium on the transport unit or an image forming unit corresponding to the position of the trailing end of the recording medium on the basis of the sensing result of at least one of the first sensor and the second sensor.

6. The image forming apparatus according to claim 2, further comprising:
a cover openably covering a portion of a transport path of the recording medium on at least one of an upstream side and a downstream side of the transport unit,
wherein, when a jam occurs, the report unit determines whether an other end of the recording medium opposite to an end which is positioned on the transport unit, is at a position corresponding to the cover, and when it is determined that the other end of the recording medium is at the position, reports an indication that a jam clear from the cover is possible, instead of reporting the image forming unit.

7. The image forming apparatus according to claim 1,
wherein, if there are a plurality of image forming units corresponding to the position of the recording medium, the report unit determines a retraction order of the image forming units, and reports the image forming units on the basis of the retraction order.

8. The image forming apparatus according to claim 7,
wherein, when the retraction order is determined, the report unit sets, as an highest-order image forming unit, an image forming unit corresponding to a position of one of a leading end and a trailing end of the recording medium on the transport unit from among the plurality of image forming units that correspond to the position of the recording medium, and sets, as a lower-order image forming unit, an image forming unit closer to the opposite end of the recording medium.

9. The image forming apparatus according to claim 1,
wherein, when a jam occurs, if a plurality of recording mediums are present on the transport unit, the report unit reports an image forming unit corresponding to the position of each recording medium.

10. The image forming apparatus according to claim 1,
wherein the plurality of image forming units are configured to be individually detached in a vertical direction with respect to a transport surface of the recording medium in the transport unit.

11. An image forming apparatus comprising:
a belt which transports a recording medium;
a sensor;
a plurality of process cartridges positioned along a portion of the belt;
a plurality of jam areas, each jam area corresponding to one of the plurality of process cartridges; and
a controller which detects an occurrence of a jam of the recording medium, and when a jam has occurred, determines one or more jam areas in which the recording medium is located based on an output of the sensor and reports the process cartridge corresponding to the one or more jam areas.

12. The image forming apparatus according to claim 11,
wherein each jam area comprises a portion of the belt that is upstream and a portion of the belt that is downstream of the corresponding process cartridge.

13. The image forming apparatus according to claim 11,
wherein the controller determines the one or more jam areas based on a position of a leading end of the recording medium.

14. The image forming apparatus according to claim 11,
wherein the controller determines the one or more jam areas based on a position of a trailing end of the recording medium.

15. The image forming apparatus according to claim 11,
wherein the controller determines the one or more jam areas based on a position of a leading end of a recording medium and a trailing end of the recording medium.

16. The image forming apparatus according to claim 11,
wherein the controller determines the one or more jam areas based on a position of a leading end of a first recording medium and a trailing end of a second recording medium.

17. An image forming apparatus comprising:
a belt which transports a recording medium;
a plurality of process cartridges positioned along a portion of the belt, each process cartridge forming a nip portion on the belt;
a first sensor located upstream of the process cartridges;
a second sensor located downstream of the process cartridges;
a plurality of jam areas, each jam area corresponding to one of the nip-portions of the plurality of process cartridges; and
a controller which detects an occurrence of a jam of the recording medium, and when a jam has occurred, determines one or more jam areas in which the recording medium is located based on an output of the first and second sensors and reports the process cartridge corresponding to the one or more jam areas.

18. The image forming apparatus according to claim 17,
wherein each jam area comprises a portion of the belt that is upstream and a portion of the belt that is downstream of the corresponding nip-portion.
